(19) United States
(12) Patent Application Publication
(10) Pub. No.: US 2005/0061605 A1
(43) Pub. Date: Mar. 24, 2005

(54) Fraud prevention

(76) Inventors: Malcolm Reginald Hallis Bell, Leeds (GB); Andrew William Barson, Cheshire (GB)

Correspondence Address: MORGAN & FINNEGAN, L.L.P., 3 WORLD FINANCIAL CENTER, NEW YORK, NY, 10281-2101, US

(21) Appl. No.: 10/616,852

(22) Filed: Jul. 9, 2003

(30) Foreign Application Priority Data
Aug. 6, 2002 (GB) 0218259.0

(51) Int. Cl. G07G 3/00; G07D 7/00

(52) U.S. Cl. 194/202

(57) ABSTRACT

An acceptor for money items such as coins or banknotes produces a money item parameter signal x₁ as a function of a sensed characteristic of a money item. A store (12) provides data which defines a window corresponding to a normal acceptance range of values of the parameter signal for a money item of a particular denomination (NAW), the range including relatively high and low acceptance probability regions (RAW, USM) which correspond to a relatively high or low probability or an occurrence of a sensed money item of a particular denomination. The processor 11 determines when an occurrence of the parameter signal x₁ falls within the low probability region (USM) and then for the next sensed money item compares the value of the parameter signal (x₁) with window data corresponding to a restricted acceptance range (RAW) so as only to accept the second money item if the corresponding value of the parameter signal x₁ falls within the restricted acceptance range.

### FIELD OF THE INVENTION

This invention relates to a method of limiting fraud in connection with coin or note operated machines.

### BACKGROUND OF THE INVENTION

Coin and banknote acceptors are well known. WO-A-0048138 discloses acceptors which detect fraud attempts and modify their acceptance conditions in dependence thereon. However, each machine makes its own determination of the presence of fraudsters.

### SUMMARY OF THE INVENTION

According to the present invention, there is provided an acceptor for money items or the like, e.g. coins, tokens, bank notes and tickets, comprising sensing means for sensing parameters of an item submitted to the acceptor, processing means for determining the acceptability of an item submitted to the acceptor in the basis of the parameters thereof sensed by the sensing means and communication means, wherein the processing means is configured to respond to a condition indicative of a fraud attempt by sending an alarm signal using said communication means and to respond to such an alarm signal, received by said communication means, to modify its acceptance criteria. Said condition may be an actual fraud attempt or a condition which is suggestive of, but not determinative of, a fraud attempt, for example a sensed parameter being at the edge of an acceptance range.

Preferably, said condition relates to a sensed parameter value. However, it could be generated by fraud detection means such as means for detecting stringing.

Preferably, said modification comprises reducing an acceptance range for a sensed item parameter. However, the modification could extend to rejection of all offered items.

The nature of the communication to and from an acceptor according to the present invention will vary in dependence on circumstances. For instance, in an arcade environment or an automated ticket office, it is desirable for acceptors to be alerted to attempted frauds in real time. In such a situation, a data network, employing for example Ethernet, Bluetooth, or 802.11, protocols would be appropriate. However, in the event of the introduction of a new slug or counterfeit bank note, it would be desirable to employ acceptors according to the present invention, even if the alarm signalling were not in real-time but with alarms being transmitted and received during periodic administrative data transfers, e.g. using landline or mobile telephone connections. Furthermore, the alarm may be conveyed in a data storage means, such as the memory of a handheld acceptor administration unit, intended to be take to acceptors in turn for data transfer, rather than as signals in a network.

### BRIEF DESCRIPTION OF THE DRAWINGS

FIG. 1 illustrates a plurality of gaming machines interconnected by an network;

FIG. 2 is a schematic block diagram of a coin acceptor in accordance with the invention;

FIG. 3 is a schematic block diagram of the circuits of the acceptor shown in FIG. 2;

FIG. 4 is a distribution curve of coin parameter signals produced by the acceptor of FIG. 2;

FIG. 5 is a schematic flow diagram of processing steps carried out by the microcontroller of the acceptor of FIG. 2;

FIG. 6 is a schematic flow diagram of further processing steps carried out by the microcontroller of the acceptor of FIG. 2 and

FIG. 7 is a schematic diagram of a banknote acceptor in accordance with the invention.

### DETAILED DESCRIPTION OF THE PREFERRED EMBODIMENT

Preferred embodiments of the present invention will now be described, by way of example, with reference to the accompanying drawings.

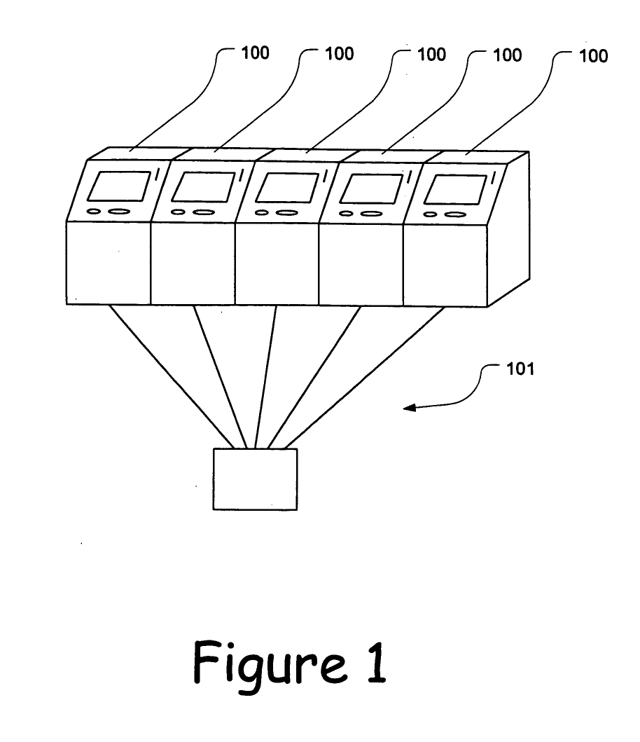

Referring to FIG. 1, a plurality of gaming machines 100 are interconnected by an Ethernet network 101. The gaming machines 100 are located in the same establishment.

Overview of Coin Acceptor

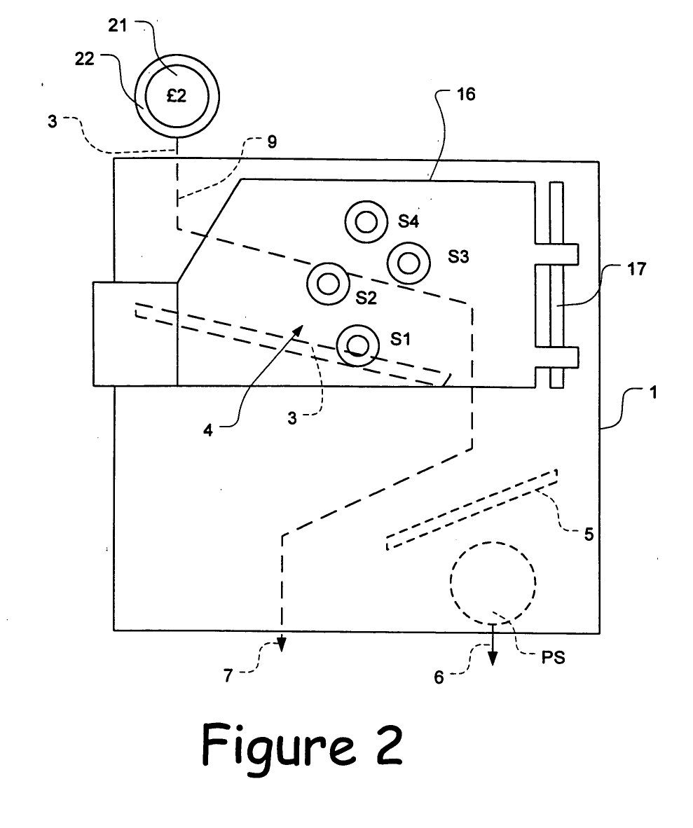

FIG. 2 illustrates the general configuration of a coin acceptor used in the gaming machines of FIG. 1. The coin acceptor is capable of validating a number of coins of different denominations, including bimet coins, for example the new euro coin set and the new UK coin set including the new bimet £2.00 coin. The acceptor includes a body 1 with a coin run-down path 2 along which coins under test pass edgewise from an inlet 3 through a coin sensing station 4 and then fall towards a gate 5. A test is performed on each coin as it passes through the sensing station 4. If the outcome of the test indicates the presence of a true coin, the gate 5 is opened so that the coin can pass to an accept path 6, but otherwise the gate remains closed and the coin is deflected to a reject path 7. The coin path through the acceptor for a coin 8 is shown schematically by dotted line 9.

The coin sensing station 4 includes four coin sensing coil units S1, S2, S3 and S4 shown in dotted outline, which are energised in order to produce an inductive coupling with the coin. Also, a coil unit PS is provided in the accept path 6, downstream of the gate 5, to act as a credit sensor in order to detect whether a coin that was determined to be acceptable, has in fact passed into the accept path 6.

The coils are energised at different frequencies by a drive and interface circuit 10 shown schematically in FIG. 2. Eddy currents are induced in the coin under test by the coil units. The different inductive couplings between the four coils and the coin characterise the coin substantially uniquely. The drive and interface circuit 10 produces corresponding digital coin parameter data signals x₁, x₂, x₃, x₄, as a function of the different inductive couplings between the coin and the coil units S1, S2, S3 and S4. A corresponding signal is produced for the coil unit PS. The coils S have a small diameter in relation to the diameter of coins under test in order to detect the inductive characteristics of individual chordal regions of the coin. Improved discrimination can be achieved by making the area A of the coil unit S which faces the coin, such as the coil S1, smaller than 72 mm², which permits the inductive characteristics of individual regions of the coin's face to be sensed.

In order to determine coin authenticity, the coin parameter signals produced by a coin under test are fed to a microcontroller 11 which is coupled to a memory in the form of an EEPROM 12. The microcontroller 11 processes the coin parameter signals x₁-x₄ derived from the coin under test and compares the outcome with corresponding stored values held in the EEPROM 12. The stored values are held in terms of windows having upper and lower value limits. Thus, if the processed data falls within the corresponding windows associated with a true coin of a particular denomination, the coin is indicated to be acceptable, but otherwise is rejected. If acceptable, a signal is provided on line 13 to a drive circuit 14 which operates the gate 5 shown in FIG. 1 so as to allow the coin to pass to the accept path 6. Otherwise, the gate 5 is not opened and the coin passes to reject path 7.

The microcontroller 11 compares the processed data with a number of different sets of operating window data appropriate for coins of different denominations so that the coin acceptor can accept or reject more than one coin of a particular currency set. If the coin is accepted, its passage along the accept path 6 is detected by the post acceptance credit sensor coil unit PS, and the unit 10 passes corresponding data to the microcontroller 11, which in turn provides an output on line 15 that indicates the amount of monetary credit attributed to the accepted coin.

The sensor coil units S each include one or more inductor coils connected in an individual oscillatory circuit and the coil drive and interface circuit 10 includes a multiplexer to scan outputs from the coil units sequentially, so as to provide data to the microcontroller 11. Each circuit typically oscillates at a frequency in a range of 50-150 kHz and the circuit components are selected so that each sensor coil S1-S4 has a different natural resonant frequency in order to avoid cross-coupling between them.

As the coin passes the sensor coil unit S1, its impedance is altered by the presence of the coin over a period of ˜100 milliseconds. As a result, the amplitude of the oscillations through the coil is modified over the period that the coin passes and also the oscillation frequency is altered. The variation in amplitude and frequency resulting from the modulation produced by the coin is used to produce the coin parameter signals X₁-x₄representative of characteristics of the coin.

The microcontroller 11 is coupled to a network interface card 23 which interfaces the microcontroller 11 to the network 101.

Processing Circuitry

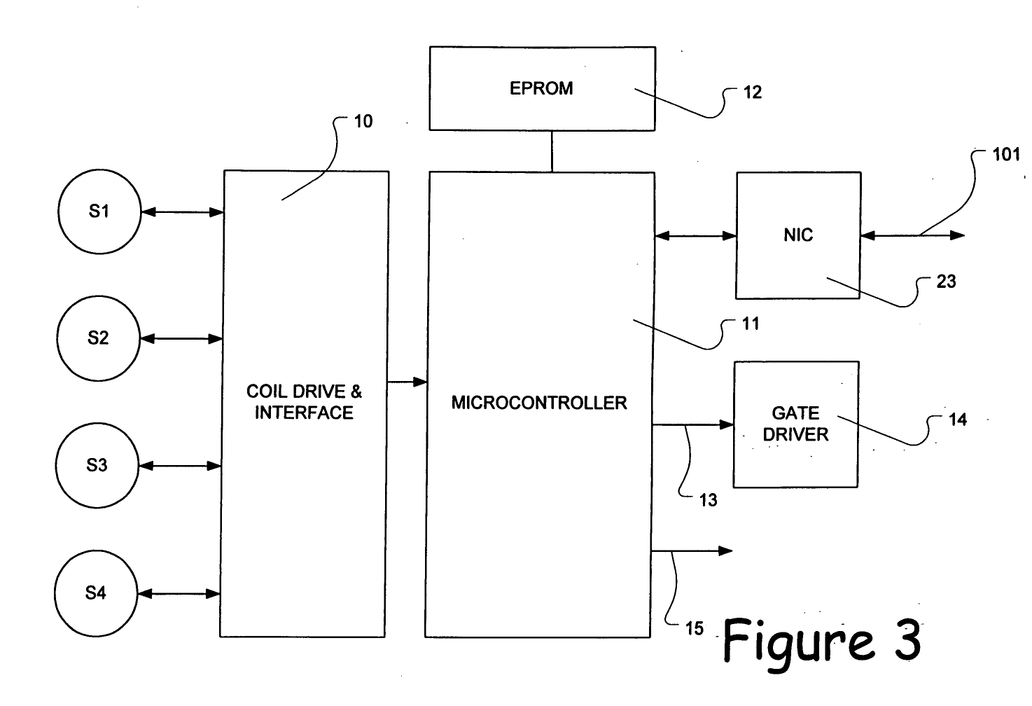

FIG. 3 illustrates a bell shaped distribution curve 20 of the values of one of the parameters, x₁, produced when a number of coins of the same denomination are passed through the validator. It can be seen that most of the occurrences of the parameter value x₁ occur at a peak value xₚ and a generally bell shaped distribution occurs around this peak value. The distribution can be determined by passing a number e.g. 100 coins of the same denomination through the validator and recording the corresponding values of x₁. The EEPROM 12 stores data corresponding to a window of acceptable values of the parameter x₁ for each denomination of coin to be accepted by the validator. In FIG. 3, one of the windows, referred to herein as a normal acceptance window NAW, is shown, extending between upper and lower window limit values w₁, w₂. The stored data in EEPROM 12 may comprise the upper and lower window limit values w₁, w₂ themselves or may comprise a mean value and a standard deviation, such that the microcontroller 11 can define the window NAW from the stored data as a predetermined number of standard deviations about the mean.

The graph of FIG. 3 can also be considered in a different way. For coins of the true denomination that corresponds to the normal acceptance window (NAW), the most likely value of parameter x₁ is the peak value xₚ and the least likely value occurs at the upper and lower window limits W₁, w₂. Whilst it is possible for an acceptable value x_{f} to occur close to one of the window limits w₂, the probability distribution shown in FIG. 3 makes clear that it is unlikely that many such values x_{f} will occur for the true coin concerned. If several values x_{f} occur, this is more likely to indicate the presence of a fraudulent distribution as shown in dotted outline, with a peak value centred on or around x_{f}. This property is used in accordance with the invention to discriminate between true coins and a set of frauds that have been manufactured to the same design which produce coin parameter values x_{f} lying within the normal acceptance window NAW. In accordance with the invention, the occurrence of more than parameter value x_{f} is considered to be unusual and likely to represent the occurrence of a fraud. In accordance with the invention, a restricted access window RAW shown in FIG. 3 is used upon detection of such a situation, as will now be described.

As shown in FIG. 3, upper and lower safety margins LSM, USM are defined in regions of relatively low probability of an occurrence of a parameter value corresponding to a true coin. It will be understood from the distribution curve 20 that it is much more likely for an occurrence of parameter signal x₁ to occur between the area of relatively high probability between dotted lines 22, 23 than in the lower and upper safety margins LSM, USM, where there is a relatively low probability of occurrence of a true value. In accordance with the invention, when the microcontroller 11 shown in FIG. 2 detects the presence of a value x_{f} in either the LSM or USM, it then changes from the normal acceptance window NAW to a restricted acceptance window RAW based on data stored in EEPROM 12, which is narrower than the normal acceptance window, as shown in FIG. 3. In practice, the RAW may correspond to the region of high probability between the dotted lines 22, 23 although different values can be used, which are non-contiguous with the LSM and USM. If the next, subsequent occurrence of the parameter signal x₁ produced by the next coin under test, occurs in e.g. the USM, close to the previous value x_{f}, the next coin will be rejected because it lies outside of the restricted access window RAW and is more likely to indicate the presence of a fraudulent coin forming part of the fraudulent coin distribution 21 than the true coin forming part of the distribution 20.

When a first coin under test exhibits a parameter signal x_{f} within either the upper or lower safety margin, USM, LSM of the normal acceptance window NAW, the coin is accepted as a true coin (assuming that its other detected parameters are satisfactory) but the acceptor then switches to a restricted access window RAW for subsequent coins and broadcasts this to the other machines 100 on the network 101. The occurrence of the first coin with parameter value x_{f} sets a flag which may comprise a counter in the microcontroller 11. The acceptor continues to use the restricted access window for a predetermined number of coins set by the counter, and the flag remains set until a number of coins with parameter signals x₁ lying within the restricted window RAW occur in succession. The number is dependent upon the distribution of coin data and the probability of a true coin legitimately falling at the limits of the distribution 20. This will vary from coin to coin but typically might be six or eight insertions of coin or could be as few as one or as many as twenty.

If another coin produces a value x₁ outside of the restricted access window prior to expiry of the count, the flag is reset and the count begins again.

Additionally, an upper security barrier USB and a lower security barrier LSB are disposed above and below the upper and lower window limits w₁, w₂ respectively. If a coin produces a parameter signal x₁ lying within either the upper or lower security barrier regions USB, LSB, the previously described process is carried out and the acceptor switches from the normal acceptance window NAW to the restricted access window RAW. This process is carried out in order to reject potentially fraudulent coins that form part of a distribution such as the fraudulent distribution 21. For example, it may be possible to find a coin of a foreign denomination which has a close, similar distribution to the true distribution 20, the foreign coin having a distribution 21. The fraudster may attempt to defraud the validator by feeding a series of the foreign coins of the same denomination through the acceptor. With the described arrangement according to the invention, the first foreign coin would be rejected if its parameter signal fell within USB because it is outside of the normal acceptance range NAW, and would cause the system to switch to the RAW to reject subsequent coins of the fraudulent coin distribution. If the first fraudulent coin's parameter signal fell within USM, it would be accepted and again would cause the system to switch from NAW to RAW for subsequent coins. Since for most of the fraudulent foreign coins, their parameter signal is more likely to be in USB than other parts of the distribution 21, there is a high probability that the first fraudulent coin will be rejected.

The acceptor may also include a timer which, after the restricted access window RAW has been adopted, returns the acceptor back to the normal acceptance window NAW after a given time period. The fraudster may insert a fraudulent coin, get it accepted by the coin acceptor which then switches to use of the restricted access window RAW. If the fraudster then gives up after a few more tries, and goes away, the timer can then time-out in time for an honest user to come and use the acceptor on the basis of the normal acceptance window.

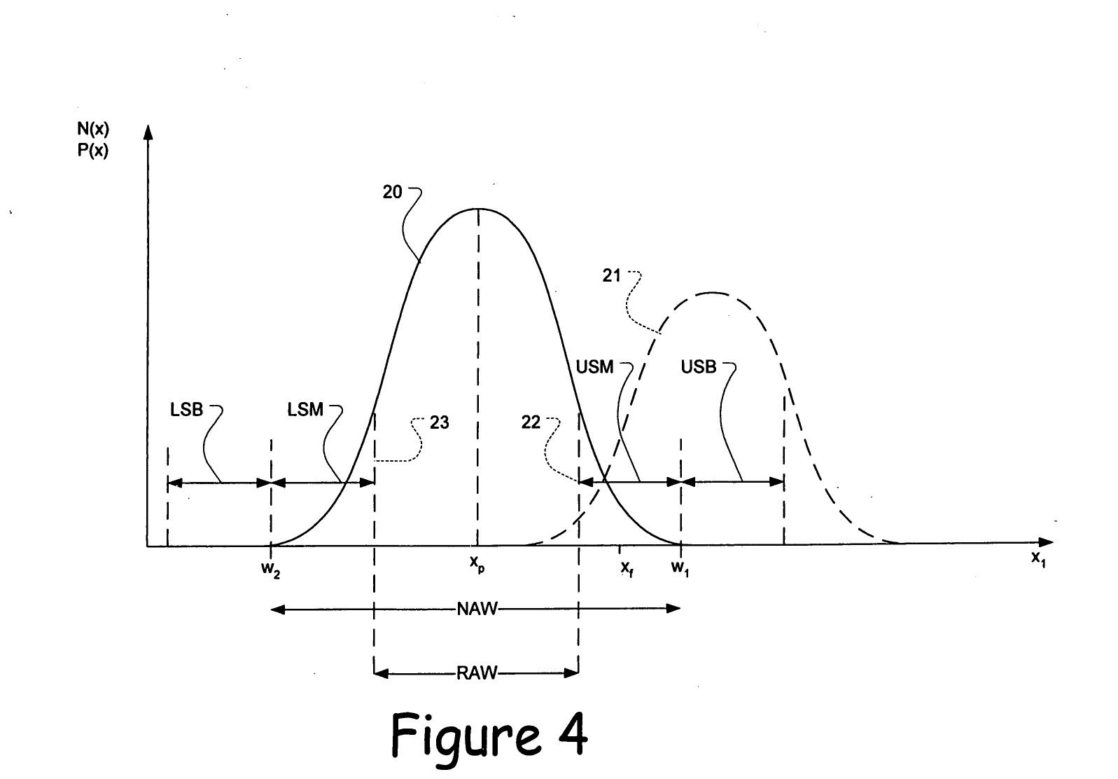

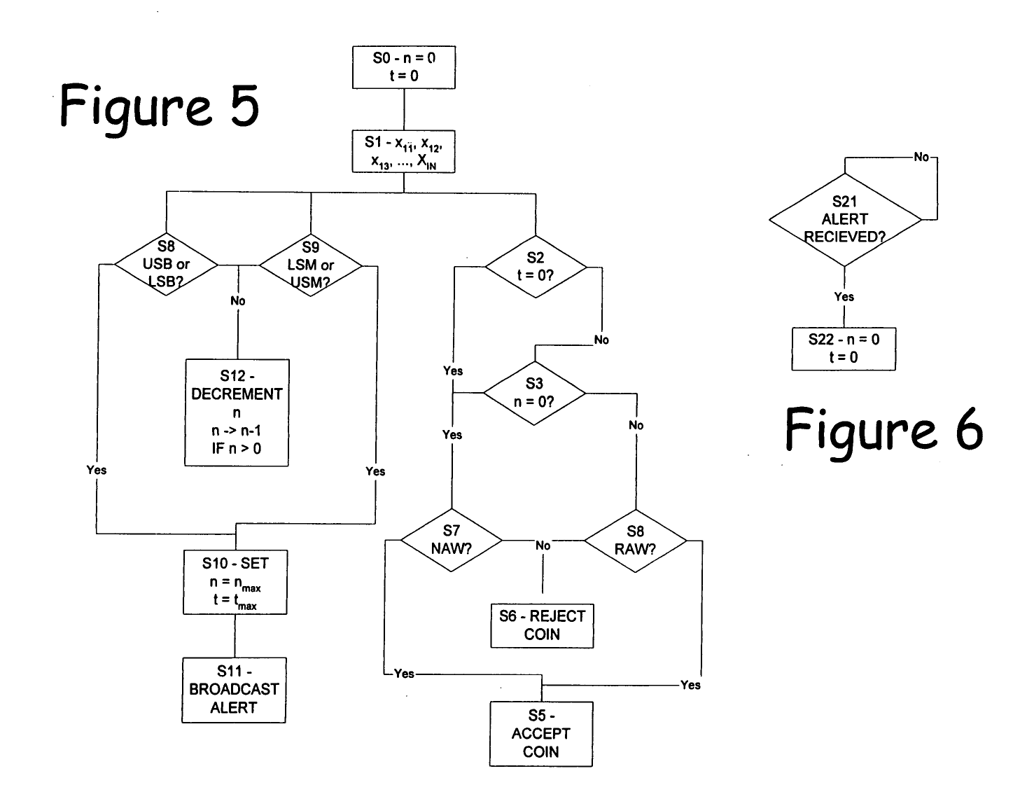

The routine followed by the microcontroller 11 is shown in more detail in FIG. 4. At step S0, the system is initialised. The aforementioned counter is set so that its operating parameter n is initialised i.e. n=0. Also, the aforementioned timer has an operating parameter t which can vary from tₘₐₓ to zero, which indicates a timed-out condition at step S0 t is initialised i.e. t=0.

At step S1, successive values of the parameter signal x_{1 1}, x_{1 2}, . . . x_{1N} are shown. These occurrences of the parameter signal are produced in response to the acceptor testing successive coins one after the other. The successive occurrences of the parameter signal are tested one after the other by the remainder of the routine as will now be explained.

Considering the first occurrence of the parameter signal x_{1 1}, produced in response to a first coin, at step S2, a test is carried out to see if the timer is active. If it is not active, t=0. This means that a sufficiently long period of time has elapsed since the acceptor was last used, indicating that it is safe to use the relatively wide, normal acceptance window NAW.

At step S3, the status of the flag counter is checked. If the flag parameter n=0, this means that the flag is not set and that it is safe to use the normal acceptance window NAW. However, if the flag counter is set whilst the timer is running, it is not safe to use the normal acceptance window because the conditions indicate that a coin, previously accepted by the acceptor 1 or the acceptor of one of the other machines 100, has triggered the flag counter of an acceptor whilst its timer is running. As a result, the value of x_{1 1} needs to be compared with the restricted access window RAW. This is carried out at step S4. If the value of x_{1 1}, falls within the restricted access window RAW, the coin is accepted at step S5 but otherwise is rejected at step S6.

As previously mentioned, if the timer or the counter flag are set to 0, it is safe to use the normal acceptance window NAW. This test is carried out at step S7 and the coin is either accepted or rejected at step S5 or S6.

In addition to comparing the parameter value against either of the acceptance windows, each occurrence of the parameter value is compared with the upper and lower safety margins and safety barriers. These tests are performed at steps S8 and S9. If the parameter value signal x_{1 1} falls within any of the barriers or margins USB, USM, LSB, LSM, this indicates that the aforementioned flag needs to be set and that the timer t should be set running and an alert must be broadcast to the other machines 100. These activities are carried out at steps S10, at which the count parameter n is set to a predetermined maximum value nₘₐₓ, and S11 at which the alert is broadcast. It will be understood that nₘₐₓ and an integer number corresponding to the successive number of coins which subsequently need to be found to be true when using the relatively narrow restricted access window RAW. The value of the timer interval t is set to tₘₐₓ which corresponds to the period of time for which the timer will run until reaching a value t=0. This, therefore sets the time after which the acceptor will recover and switch back to use the normal acceptance window NAW after a period of using the restricted access window RAW (step S2).

If the value of the parameter signal x_{1 1} does not fall within any of the margins or barriers tested by step S8, S9, this indicates that the parameter signal x_{1 1}, on the assumption that the coin has been accepted, falls within the restricted access window RAW. In this situation, the counter parameter n needs to be decremented, if it is not already zero. This occurs at step S12.

Considering the situation where the first occurrence of the coin parameter signal x_{1 1} falls within the upper safety margin USM. In this situation, t=0 and n=0 so that the routine passes to step S7 at which the value is compared with the normal acceptance window NAW. The value of x_{1 1} falls within the window and hence the coin is accepted at step S5.

Additionally, the value of x_{1 1} is found to be within the upper safety margin USM, at step S9. As a result, the flag counter parameter n is set to nₘₐₓ and the timer parameter t is set to tₘₐₓ at step S10.

When a second coin is entered a second occurrence of the coin parameter signal x₁ is produced, namely x_{1 2}. At step S2, the timer is now set to t≠0 and so the process moves to step S3. The parameter n≠0 and so the value of x_{1 2} is compared with the restricted access window RAW at step S4. The value is either accepted or rejected. Assuming it is accepted, and falls outside of the margins and barriers tested at step S8 and S9, the counter parameter n is decremented at step S11. The timer t is running all the time towards zero.

The process continues with the subsequent occurrences of the parameter x₁ until the timer t=0 or the counter flag n=0. The acceptor then reverts to the use of the normal acceptance window NAW.

Referring to FIG. 6, when an acceptor 1 receives a broadcast alert from another machine 100 (S21), it sets its timer running and sets its count flag to nₘₐₓ and timer to tₘₐₓ (S22).

The previously described process thus relates to one of the coin parameter signals x₁. However, as previously explained, four different coin parameter signals x₁-x₄ are produced in this example and in fact, in practice, up to fourteen different individual parameter signals may be processed. The routine performed according to FIG. 4 may be carried out for each individual coin parameter signal with each having its own normal access window and restricted access window, controlled as previously described, with each parameter signal being processed independently of the others. Alternatively, to simplify the processing, the occurrence of one parameter signal falling within its respective USB, LSB, LSM or USM may trigger the use of an individual restricted access window for all of the coin parameter signals concurrently.

Other modifications are possible. In the routine shown in FIG. 3, the counter flag is clocked downwardly from a first predetermined number nₘₐₓ. Typically nₘₐₓ is in a range of 6 to 20 inclusive. Whilst n≠0 the restricted access window RAW is used (step S3). However, when n=0 i.e. when 6 to 20 true coins have been detected, the normal window NAW is used. The occurrence of a single fraudulent coin will then re-trigger the use of the RAW (steps S8-S10). However, if desired a different pre-selected number p of occurrences of fraudulent coin could be used to re-set n=nₘₐₓ and thereby re-trigger the use of the RAW. The pre-selected number p of occurrences of fraudulent coin is selected to be less than the predetermined number n to thereby improve the sensitivity of the system. Preferably the number p is 1 as described with reference to FIG. 4 to maximise the sensitivity to fraudulent coins, although a larger value of p may in some instances be desirable to provide system damping.

In another modification, the routine may switch from the normal acceptance window NAW to the RAW in response to a coin parameter signal falling within a very narrow portion of the NAW itself, which may signify a fraudulent coin in certain circumstances.

Banknote Acceptor

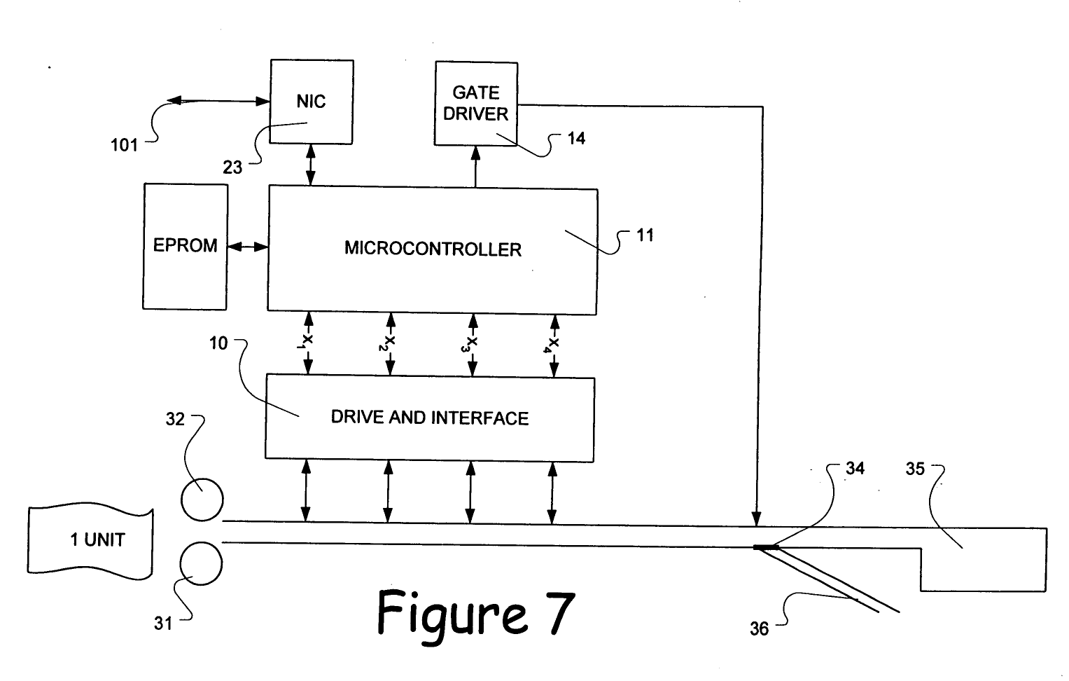

The previously described routines are also applicable to banknote acceptors and an example is shown in FIG. 7. A banknote 30 to be tested is inserted between driven rollers 31, 32 so as to pass over a sensing platen 33 over which a series of banknote sensors are disposed. In this example, four sensors S1, S2, S3 and S4 are shown schematically. The sensors may include optical sensors for sensing the length, width or thickness of the banknote, sensors for detecting reflected light from the banknote in order to analyse the spectral response. Alternatively, the light may be sensed in transmission through the banknote. One or more individual predetermined parts of the banknote may be measured. Also, the presence of magnetic printing ink may be detected as described in U.S. Pat. No. 4,864,238. The sensors S1-S4 are driven and processed by drive and interface circuitry 10 to produce individual parameter signals X₁, x₂, X₃, x₄ These parameter signals are similar to the corresponding signals described with reference to FIGS. 2 and 3 for the coin acceptor although indicative of different parameters relating to a banknote. The resulting signals thus can be processed according to the previously described routine. The parameter signals are passed to a microcontroller 11 connected to an EEPROM 12 that contains stored window values. The parameter signals are compared with stored windows corresponding to acceptable banknotes in the manner previously described with reference to FIG. 4 and upon detection of an acceptable banknote, an output is provided on line 13 to a gate driver 14 which operates a gate 34. If the banknote is found to be acceptable, it is passed to a store 35 but otherwise is fed into a reject path 36 and passes out of the acceptor.

Thus, in accordance with the invention, the banknote acceptor is provided with increased security to discriminate against a fraudster inserting a series of fraudulent banknotes all made according to the same design, which individually would fall within the normal acceptance window for an acceptable denomination of banknote.

Whilst the invention has been described by way of example in relation to a coin acceptor and a bank note acceptor it will be understood that it is applicable to other money items such as tokens which are sometimes used instead of coins and other sheet members which have an attributable money value including, but not limited to, credit and debit cards.

1. An acceptor for money items or the like comprising:
sensing means for sensing parameters of an item submitted to the acceptor,
processing means for determining the acceptability of an item submitted to the acceptor in the basis of the parameters thereof sensed by the sensing means, and
communication means,
wherein the processing means is configured to respond to a condition indicative of a fraud attempt by sending an alarm signal using said communication means and to respond to such an alarm signal, received by said communication means, to modify its acceptance criteria.

2. An acceptor according to claim 1, wherein said condition relates to a sensed parameter value.

3. An acceptor according to claim 2, wherein said condition comprises a sensed parameter falling within a marginal region of an acceptance range therefor.

4. An acceptor according to claim 1, wherein said modification comprises reducing an acceptance range for a sensed money item parameter.

5. An acceptor according to claim 4, wherein said condition relates to a sensed parameter value.

6. An acceptor according to claim 5, wherein said condition comprises a sensed parameter falling within a marginal region of an acceptance range therefor.

7. An acceptor according to claim 1, wherein the communication means comprises data network communication means.

8. An acceptor for money items or the like comprising:
sensing means for sensing parameters of an item submitted to the acceptor,
processing means for determining the acceptability of an item submitted to the acceptor in the basis of the parameters thereof sensed by the sensing means, and
data network communication means,
wherein the processing means is configured to respond to a condition indicative of a fraud attempt by sending an alarm signal using said communication means and to respond to such an alarm signal, received by said communication means, to modify its acceptance criteria.

9. An acceptor according to claim 8, wherein said condition relates to a sensed parameter value.

10. An acceptor according to claim 9, wherein said condition comprises a sensed parameter falling within a marginal region of an acceptance range therefor.

11. An acceptor according to claim 8, wherein said modification comprises reducing an acceptance range for a sensed money item parameter.

12. An acceptor according to claim 11, wherein said condition relates to a sensed parameter value.

13. An acceptor according to claim 12, wherein said condition comprises a sensed parameter falling within a marginal region of an acceptance range therefor.

14. A coin- or banknote-operated machine including an acceptor for money items or the like, the acceptor comprising:
sensing means for sensing parameters of an item submitted to the acceptor,
processing means for determining the acceptability of an item submitted to the acceptor in the basis of the parameters thereof sensed by the sensing means, and
communication means,
wherein the processing means is configured to respond to a condition indicative of a fraud attempt by sending an alarm signal using said communication means and to respond to such an alarm signal, received by said communication means, to modify its acceptance criteria.

15. A machine according to claim 14, wherein said condition relates to a sensed parameter value.

16. A machine according to claim 15, wherein said condition comprises a sensed parameter falling within a marginal region of an acceptance range therefor.

17. A machine according to claim 14, wherein said modification comprises reducing an acceptance range for a sensed money item parameter.

18. A machine according to claim 17, wherein said condition relates to a sensed parameter value.

19. A machine according to claim 18, wherein said condition comprises a sensed parameter falling within a marginal region of an acceptance range therefor.

20. A machine according to claim 14, wherein the communication means comprises data network communication means.

21. A coin- or banknote-operated machine including an acceptor for money items or the like, the acceptor comprising:
sensing means for sensing parameters of an item submitted to the acceptor,
processing means for determining the acceptability of an item submitted to the acceptor in the basis of the parameters thereof sensed by the sensing means, and
data network communication means,
wherein the processing means is configured to respond to a condition indicative of a fraud attempt by sending an alarm signal using said communication means and to respond to such an alarm signal, received by said communication means, to modify its acceptance criteria.

22. A machine according to claim 21, wherein said condition relates to a sensed parameter value.

23. A machine according to claim 22, wherein said condition comprises a sensed parameter falling within a marginal region of an acceptance range therefor.

24. A machine according to claim 21, wherein said modification comprises reducing an acceptance range for a sensed money item parameter.

25. A machine according to claim 24, wherein said condition relates to a sensed parameter value.

26. A machine according to claim 25, wherein said condition comprises a sensed parameter falling within a marginal region of an acceptance range therefor.

27. A system comprising a plurality of coin- or banknote-operated machines, each including an acceptor and interconnected in a data network, said acceptors each comprising:
sensing means for sensing parameters of an item submitted to the acceptor,
processing means for determining the acceptability of an item submitted to the acceptor in the basis of the parameters thereof sensed by the sensing means, and
data network communication means for communication via said data network,
wherein said processing means is configured to respond to a condition indicative of a fraud attempt by sending an alarm signal using said communication means and to respond to such an alarm signal, received by said communication means, to modify its acceptance criteria.

28. A system according to claim 27, wherein said condition relates to a sensed parameter value.

29. A system according to claim 28, wherein said condition comprises a sensed parameter falling within a marginal region of an acceptance range therefor.

30. A system according to claim 27, wherein said modification comprises reducing an acceptance range for a sensed money item parameter.

31. A system according to claim 30, wherein said condition relates to a sensed parameter value.

32. A system according to claim 31, wherein said condition comprises a sensed parameter falling within a marginal region of an acceptance range therefor.
